(19) United States
(12) Patent Application Publication
(10) Pub. No.: US 2007/0287936 A1
(43) Pub. Date: Dec. 13, 2007

(54) Continuous Passive Motion Device

(76) Inventors: Taisuke Matsushita, Tokyo (JP); Yutaka Sato, Tokyo (JP); Makoto Konami, Tokyo (JP); Kazuaki Hiramatsu, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/576,722

(22) PCT Filed: Jul. 11, 2005
(86) PCT No.: PCT/JP05/12759

§ 371 Date: Apr. 5, 2007

(30) Foreign Application Priority Data
Oct. 12, 2004 (JP) 2004-297772

(51) Int. Cl. A61H 1/00

(52) U.S. Cl. 601/5

(57) ABSTRACT

A continuous passive motion device includes a base, a link member connected to the base rotatably about a first rotary shaft, a lower-leg-holding section connected to the link member rotatably about a second rotary shaft, and a driving means for bending/stretching the link member and the lower-leg-holding section. A first positioning section for positioning a hip joint is provided on the base. A second positioning section for positioning a knee joint is provided in the vicinity of the second rotary shaft. The first and second rotary shafts are respectively offset in the same direction from the first and second positioning section.

### TECHNICAL FIELD

The present invention relates to a continuous passive motion (CPM) device for preventing contracture by continuously moving a hip joint and a knee joint.

### BACKGROUND ART

In a conventional continuous passive motion device, hip joints and knee joints of a patient are bent and stretched by driving a thigh-driving device and a lower-leg-driving device while holders disposed on tips of arms of the thigh-driving device are attached to thighs of the patient, and holders disposed on tips of arms of the lower-leg-driving device are attached to lower leg regions of the patient (see, for example, Patent Document 1).

Patent Document 1: JP 2000-51297 A

### DISCLOSURE OF THE INVENTION

### Problems to be solved by the Invention

In the above-mentioned conventional continuous passive motion device, because movements of only the thighs and lower leg regions are regulated, for example, if the position of the waist of a patient is shifted, there is a fear that it is not possible to move the hip joint and the knee joints in a desired mode. In contrast, if it is intended that the rotational center of a driving mechanism is aligned with rotational centers of the joints, rotational centers of the driving mechanism can be disposed on both sides of the knee joints, but rotational centers of the driving mechanism can be disposed on only one side of a hip joint (body side) because the hip joint is positioned in a body. For this reason, it is not possible to obtain sufficient strength for supporting legs, so that stable movements may not always be possible. Also, it was necessary to reassemble the device and use alternative devices based on whether the right leg or the left leg is moved.

The present invention has been made in view of solving the above-mentioned problems, and it is an object of the present invention to obtain a continuous passive motion device which can more stably move a hip joint and a knee joint about the rotational centers of the joints with a simple configuration.

### Means for Solving the Problems

A continuous passive motion device according to the present invention includes: a base onto which a buttock is mounted; a link body connected to the base to be rotatable about a first rotary shaft as a center; a lower-leg-holding section, for supporting a lower leg region, connected to the link body rotatably about a second rotary shaft as center; and driving means for bending and stretching the link body and the lower-leg-holding section so that the position of the second rotary shaft varies along an arc about the first rotary shaft as a center, in which: a first positioning section for positioning a hip joint is provided at the base; a second positioning section for positioning a knee joint is provided in the vicinity of the second rotary shaft; and the first and second rotary shafts are offset in the same direction with respect to the first and second positioning sections, respectively, when the link body and the lower-leg-holding section are stretched.

### BRIEF DESCRIPTION OF THE DRAWINGS

FIG. 1 is a perspective view showing a continuous passive motion device according to an embodiment of the present invention.

FIG. 2 is a drawing showing a schematic configuration of an extended state in the shortest condition of the continuous passive motion device of FIG. 1.

FIG. 3 is a drawing showing a schematic configuration of a folded state in the shortest condition of the continuous passive motion device of FIG. 1.

FIG. 4 is a drawing showing a schematic configuration of the extended state of the continuous passive motion device of FIG. 1 in the longest condition.

FIG. 5 is a drawing showing a schematic configuration of the folded state of the continuous passive motion device of FIG. 1 in the longest condition.

FIG. 6 is an explanatory drawing showing movement locus of the continuous passive motion device of FIG. 1 in the shortest condition.

FIG. 7 is an explanatory drawing showing the movement locus of the continuous passive motion device of FIG. 1 in the longest condition.

### BEST MODES FOR CARRYING OUT THE INVENTION

Preferable embodiments of the present invention will be explained below with reference to the drawings.

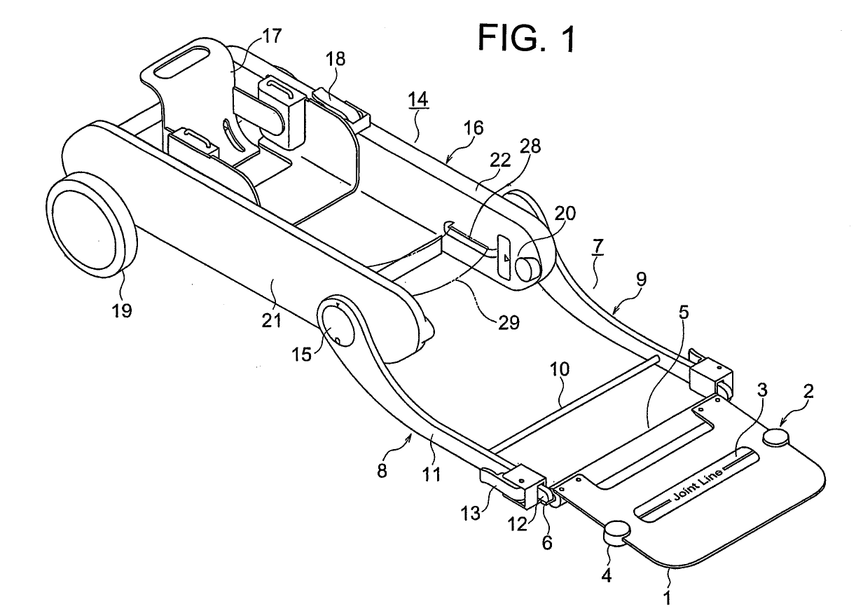

FIG. 1 is a perspective view showing a continuous passive motion device according to an embodiment of the present invention. In the drawing, a first positioning section 2 for positioning a hip joint of a patient is disposed on a plate-like base 1 onto which a buttock of the patient are mounted. The first positioning section 2 includes a line mark 3 drawn in a center of the base 1 and a pair of columnar marking members 4 fixed to both ends in a width direction of the base 1. The marking members 4 are disposed on a line extending from the line mark 3. The line mark 3 and the marking members 4 are colored differently from the base 1.

A cylindrical shaft-supporting member 5 is connected to an end portion of the base 1. A first rotary shaft 6 is inserted into the shaft-supporting member 5 so as to be rotatable. A link body 7 is connected to both end portions of the first rotary shaft 6. That is, the link body 7 is connected to the base 1 rotatably about the first rotary shaft 6.

In addition, the link body 7 has first and second arms 8 and 9 respectively disposed so as to have an interval in an axial direction of the first rotary shaft 6 (in a width direction of the base 1), and a reinforcing member 10 fixed between the arms 8 and 9 in parallel with the first rotary shaft 6. The arms 8 and 9 each have a main arm member 11, an insertion section 12 extendably inserted into the main arm member 11, and a first locking mechanism 13 for locking a drawing amount of the insertion section 12 from the main arm member 11. The first locking mechanisms 13 are provided at end portions of the main arm members 11 on the side of the first rotary shaft 6. Also, a holder such as a belt for holding the thigh more securely can be provided at the link body 7.

It is possible to vary the drawing amount of the insertion section 12 from the main arm member 11 by releasing the locked state of the first locking mechanisms 13. This allows the total length of the link body 7 be adjustable in a direction orthogonal with respect to the first rotary shaft 6. The present device is configured to accommodate a variety of patient heights by adjusting the total length of the link body 7. The end portions of the insertion sections 12 drawn from the main arm members 11 are connected to the first rotary shaft 6. Also, midsections of the main arm members 11 are inflected (or bent) so that end portions opposite to the first rotary shaft 6 are positioned higher than the end portions on the side of the first rotary shaft 6.

A lower-leg-holding section 14 for holding a lower leg region of the patient is connected to the end portions opposite to the first rotary shaft 6 of the main arm members 11 rotatably about second rotary shafts 15. The second rotary shafts 15 are in parallel with the first rotary shaft 6. The lower-leg-holding section 14 has a holding-section main body 16, a heel-receiving section 17 configured to freely slide in a longitudinal direction of the holding-section main body 16, a second locking mechanism 18 for locking the displacement of the heel-receiving section 17 with reference to the holding-section main body 16, and a pair of rollers 19 provided at the end portions of the holding-section main body 16 opposite to the link body 7. The present device is configured to be able to deal with a variety of patient heights by disposing the heel-receiving section 17 so as to freely slide in the longitudinal direction of the holding-section main body 16. Also, the a pair of rollers 19 are configured so that lower end portions of side wall sections 21 and 22 can move smoothly when the link body 7 and the lower-leg-holding section 14 fold.

Second positioning sections 20 for positioning a knee joint of the patient are disposed in the vicinity of the second rotary shafts 15 of the lower-leg-holding section 14. The holding-section main body 16 has the first and second side wall sections 21 and 22 that are disposed in parallel with each other. The second positioning sections 20 are provided at end portions, on the side of the base 1, of inner wall surfaces of the first and second side wall sections 21 and 22 that face to each other. The main arm members 11 are connected to the first and second side wall sections 21 and 22 from the outside of the holding-section main body 16. The rotational axes of the rollers 19 are in parallel with the first and second rotary shafts 6 and 15. On positions on inner sides of the first and second side wall sections 21 and 22 corresponding to the second rotary shafts 15, a pair of holders 28 are disposed so as to face to each other. A belt, for example a cloth belt 29 is disposed between the side wall sections 21 and 22 so as to hold the lower leg region more securely via the holders 28. The belt 29 is flexible and supports the lower leg region in a position substantially behind the rotary shafts 15.

When the link body 7 and the lower-leg-holding section 14 are extended (state of FIG. 1), the first and second rotary shafts 6 and 15 are offset in the same direction with respect to the first and second positioning sections 2 and 20, respectively. That is, when the continuous passive motion device is in use, a position of the rotational center of the link body 7 with respect to the base 1 is offset from a position of the rotational center of the hip joint, and a position of rotational center of the lower-leg-holding section 14 with respect to the link body 7 is offset from a position of rotational center of the knee joint.

Further, the offset dimension (for example, approximately 100 mm) from the first positioning section 2 to the first rotary shaft 6 is different from the offset dimension (for example, approximately 80 mm) from the second positioning sections 20 to the second rotary shafts 15. Furthermore, an interval between the second rotary shafts 15 and the second positioning sections 20 is fixed. Still further, the interval between the first rotary shaft 6 and the second rotary shafts 15 is adjustable by varying the total length of the link body 7.

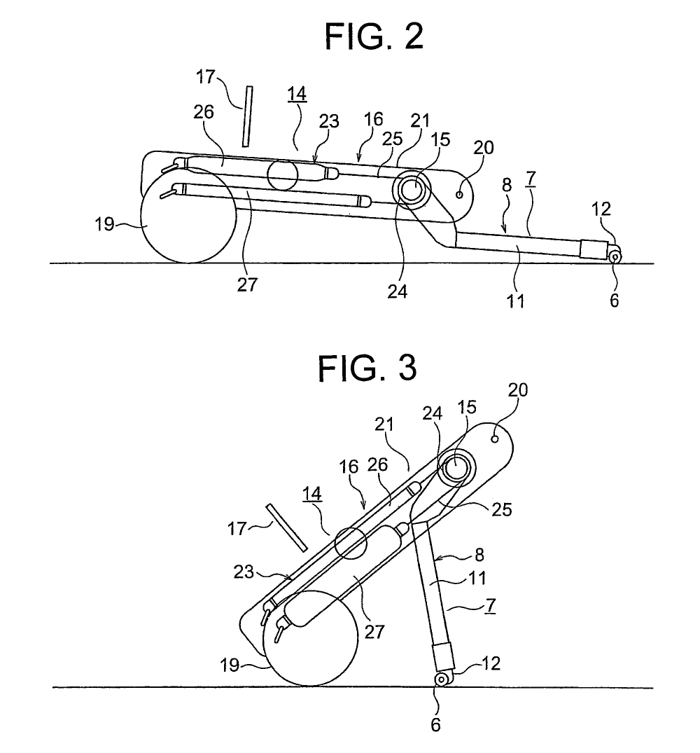

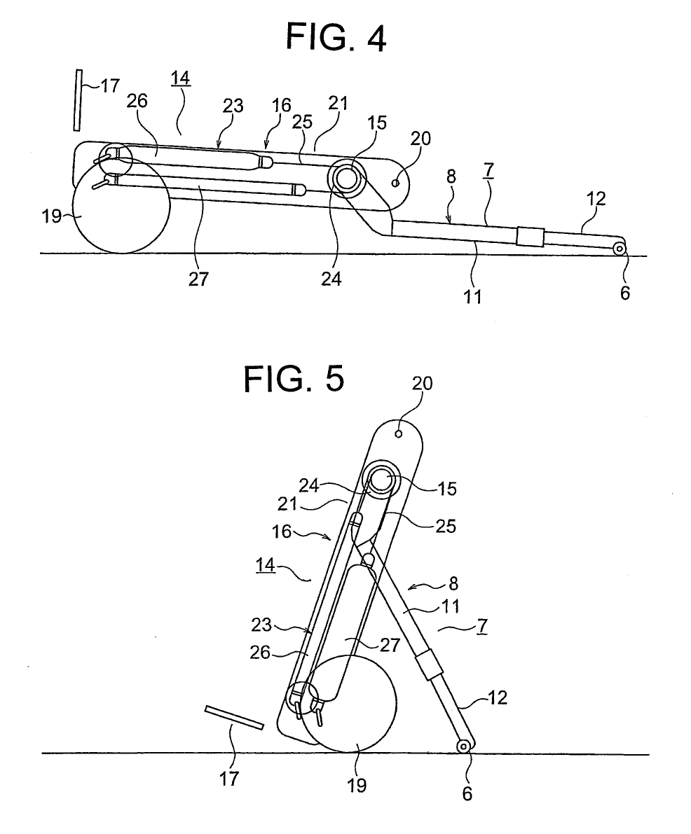

FIG. 2 is a drawing showing a schematic configuration of an extended state in the shortest condition of the continuous passive motion device of FIG. 1, FIG. 3 is a drawing showing a schematic configuration of a folded state in the shortest condition of the continuous passive motion device of FIG. 1, FIG. 4 is a drawing showing a schematic configuration of the extended state in the longest condition of the continuous passive motion device of FIG. 1, and FIG. 5 is a drawing showing a schematic configuration of the folded state in the longest condition of the continuous passive motion device of FIG. 1.

A driving means 23 is contained in the first side wall section 21 for bending and stretching the link body 7 and the lower-leg-holding section 14 so that the positions of the second rotary shafts 15 vary along an arc around the first rotary shaft 6 as a center. The driving means 23 has a driving pulley 24 fixed coaxially with the second rotary shafts 15, a driving wire 25 wound around the driving pulley 24, a first tube-shaped air actuator 26 connected in between one end portion of the driving wire 25 and an inner portion of the first side wall section 21, and a second tube-shaped air actuator 27 connected in between the other end portion of the driving wire 25 and the inner portion of the first side wall section 21. The driving pulley 24 rotates together with the second rotary shaft 15 and the main arm members 11 with respect to the first side wall section 21.

The first and second tube-shaped actuators 26 and 27 each have an inner tube and a meshy sleeve (mesh-coated member) for covering an outer periphery of the inner tube. The inner tubes are formed of an elastic member, for example, butyl rubber or the like. An air-feeding-and-exhausting unit for feeding air to and exhausting air from the inner tube is connected to one end portion of each inner tube in longitudinal directions thereof via a feeding-and-exhausting pipe. To the other end portion of each inner tube in the longitudinal direction thereof, a bush is inserted and the inner tube is sealed in an air tight manner, and driving wire 25 is connected.

Each meshy sleeve is formed of, for example, linear members such as high tension textiles or the like which do not have stretchability. Both end portions of each meshy sleeve in the longitudinal direction are clinched by clinchers, and thus, the meshy sleeve is fixed to both end portions of the inner tube.

The inner tube inflates when air is supplied to the inner section thereof. In this state, since the linear member forming the meshy sleeve is not stretchable, the inflation of the inner tube is converted to contraction of overall length of the actuator. That is, when air is supplied, diameters of the first and second tube-shaped actuators 26 and 27 are enlarged while lengths thereof are reduced. Due to the reduction in length, the first and second tube-shaped actuators 26 and 27 produce driving force (pulling force).

The driving force produced by the first and second tube-shaped actuators 26 and 27 is transmitted to the driving pulley 24 via the driving wire 25, and thus, the driving pulley 24, the second rotary shafts 15, and the main arm member 11 are rotated.

By supplying air into the second tube-shaped air actuator 27 while discharging the air in the first tube-shaped air actuator 26 from the state of FIGS. 2 and 4, the second tube-shaped air actuator 27 is reduced in length, and the first tube-shaped air actuator 26 is extended in length, and thus, the driving pulley 24 is rotated in a clockwise direction in the drawings. This allows the main arm member 11 to rotate in a clockwise direction, and the condition of the entire device is converted into a folded state as shown in FIGS. 3 and 5. In contrast, the entire device is restored to the extended state by supplying air into the first tube-shaped air actuator 26 while discharging the air in the second tube-shaped air actuator 27 from the state as shown in FIGS. 3 and 5.

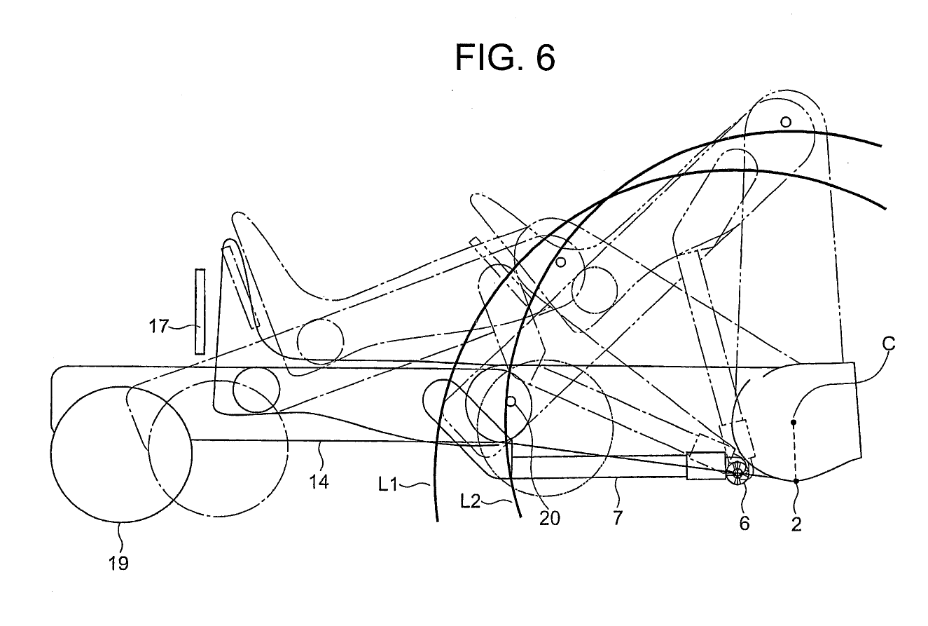

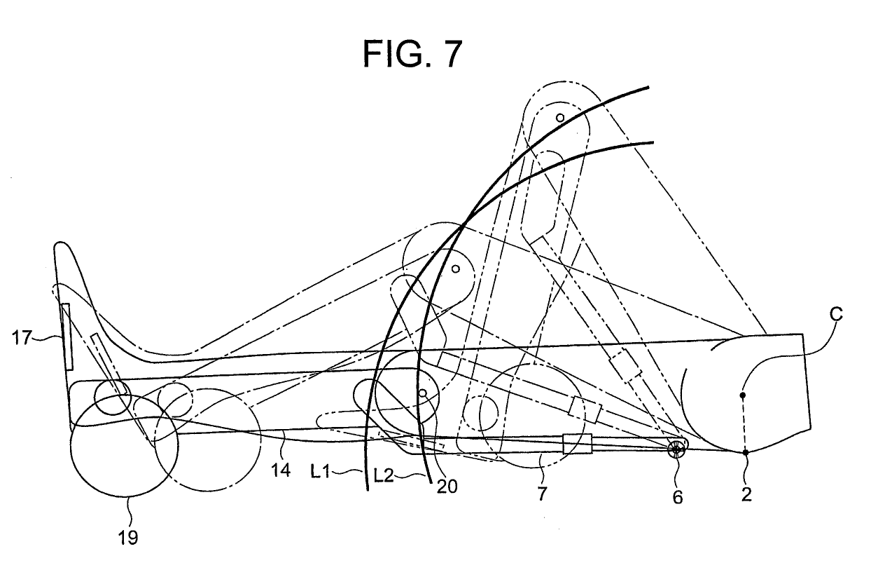

Next, operation will be explained. FIG. 6 is an explanatory drawing showing movement locus of the continuous passive motion device of FIG. 1 in the shortest condition, and FIG. 7 is an explanatory drawing showing the movement locus of the continuous passive motion device of FIG. 1 in the longest condition. In FIGS. 6 and 7, full lines indicate the extended state of the device, dashed-two dotted lines indicate the folded state, and dashed-dotted lines indicate the intermediate state.

The overall length of link body 7 is adjusted in accordance with the length from the hip joint to the knee joint of the patient. That is, the overall length of the link body 7 is adjusted so that the knee joint is positioned substantially right beside the second positioning sections 20 when the patient lies so that the hip joint is positioned substantially at the first positioning section 2. The position of the hip joint can be inferred from a position of, for example a great trochanter. Also, the position of the first positioning section 2 may be set in advance so that the hip joint is positioned at a predetermined position if the position of the great trochanter coincides with the first positioning section 2. Further, the position of the heel-receiving section 17 is adjusted in accordance with the length of the lower leg region of the patient.

As shown in FIGS. 6 and 7, when in use, the condition of the device varies repeatedly between the extended state and the folded state under the condition that the buttock is mounted on the base 1, and the lower leg region is mounted on the lower-leg-holding section 14. The knee joint is lifted up while bending when the device is in the folded state. Also, the knee joint moves down while extending by restoring the device into the extended state. Angles of the hip joint and the knee joint are varied repeatedly in this way. In addition, variation of the angle of the joints in terms of range and rate can be set arbitrarily by controlling the air-feeding-and-exhausting unit.

In the use state as such, the positions of the second rotary shafts 15 are varied along a circular orbit L1 around the first rotary shaft 6 as a center. Meanwhile, the position of the knee joint is varied along a circular orbit L2 around a rotational center C of the hip joint. In FIGS. 6 and 7, although the orbits L1 and L2 intersect with each other, the knee joint and the second rotary shafts 15 never pass through the intersecting point of the orbits L1 and L2 simultaneously because an interval is constantly maintained between the knee joint and the second rotary shafts 15. In this way, the second rotary shafts 15 and the knee joint can make independent circular movements around respective supporting points.

In the above-mentioned continuous passive motion device in which the first positioning section 2 for positioning the hip joint is disposed on the base 1 and the second positioning sections 20 for positioning the knee joint are disposed in the vicinity of the second rotary shafts 15, since the first and second rotary shafts 6 and 15 are offset in the same direction with respect to the first and second positioning sections 2 and 20, respectively, when the link body 7 and the lower-leg-holding section 14 are extended, the positions of the knee joint can be varied around the rotational center of the hip joint, intolerable force will not be applied to the knee joint, and it is possible to move the hip joint and the knee joint more stably.

That is, by offsetting the positions of the first and second positioning sections 2 and 20 from a mechanical rotational center, it is possible to adopt a structure for supporting the thigh of the patient from both sides thereof, and the device can be configured to employ a three-point-supporting method in which positions of the hip joint, the knee joint, and the heel are regulated substantially. Therefore, it is possible to obtain sufficient strength of the device and move the hip joint and the knee joint more stably than in a case of using a two-point-supporting method in which positions of only the knee joint and the heel are regulated.

Also, since the link body 7 has the first and second arms 8 and 9 that are disposed with an interval therebetween in the axial direction of the first rotary shaft 6, and the base end portions of the first and second arms 8 and 9 are connected to the base 1 rotatably about the first rotary shaft 6, thereby making it possible to support load of the thigh at both sides of the thigh and further stabilize the movement of the device.

In addition, since the driving means 23 has the first and second tube-shaped actuators 26 and 27, it is possible to reduce the weight of the entire device.

While the tube-shaped actuators are used as driving sources in the driving means in the above-mentioned embodiment, actuators using a fluid-pressure method using other fluid may alternatively be used. Further, while the tube-shaped actuators are used in the above-mentioned embodiment, cylinder-shaped actuators may alternatively be used. Furthermore, an electric motor or the like may be used for the driving source.

Also, while a roller-type device is shown in the above-mentioned embodiment in which the rollers 19 are provided at the lower-leg-holding section 14, the present invention can be applied to a slide-type device in which end portions of the lower-leg-holding section opposite to the link body as guided along rails.

Furthermore, while the driving means 23 is provided at the lower-leg-holding section 14 side in the above-mentioned embodiment, the driving means may be provided at the link body side.

1. A continuous passive motion device, comprising:
a base onto which a buttock is mounted;
a link body connected to the base to be rotatable about a first rotary shaft as a center;
a lower-leg-holding section, for supporting a lower leg region, connected to the link body rotatably about a second rotary shaft as a center; and
driving means for bending and stretching the link body and the lower-leg-holding section so that the position of the second rotary shaft varies along an arc about the first rotary shaft as a center, wherein:
a first positioning section for positioning the hip joint is provided at the base;
a second positioning section for positioning the knee joint is provided in the vicinity of the second rotary shaft; and
the first and second rotary shafts are offset in the same direction with respect to the first and second positioning sections, respectively, when the link body and the lower-leg-holding section are stretched.

2. The continuous passive motion device according to claim 1, wherein an interval between the second rotary shaft and the second positioning section is fixed, and an interval between the first rotary shaft and the second rotary shaft is adjustable.

3. The continuous passive motion device according to claim 1, wherein the link body has first and second arms, having an interval there between, disposed in an axial direction of the first rotary shaft, and base end portions of the first and second arms are connected to the base to be rotatable about the first rotary shaft as a center.

4. The continuous passive motion device according to claim 3, wherein the first and second arms each have a main arm member, an insertion section inserted into the main arm member, and first locking mechanism for locking a drawing amount of the insertion section from the main arm member, the entire length of the link body in a direction orthogonal with respect to the first rotary shaft is adjustable by varying the drawing amount of the insertion section from the main arm member.

5. The continuous passive motion device according to claim 1, wherein the lower-leg-holding section has a supporting-section main body and a heel-receiving section slidable in a longitudinal direction of the supporting-section main body.

6. The continuous passive motion device according to claim 5, wherein the lower-leg-holding section further has a second locking mechanism for locking displacement of the heel-receiving section with respect to the supporting-section main body.

7. The continuous passive motion device according to claim 4, wherein end portions of the insertion sections are connected to the first rotary shaft, and midsections of the main arm members are bent so that end portions opposite to the first rotary shaft are positioned higher than end portions on a side of the first rotary shaft.

8. The continuous passive motion device according to claim 1, wherein the first positioning section includes a line mark provided in a center of the base.

9. The continuous passive motion device according to claim 1, wherein the first positioning section includes a marking member fixed to end portions of the base in a width direction.

10. The continuous passive motion device according to claim 5, wherein the supporting-section main body has first and second side wall sections that are in parallel with each other.

11. The continuous passive motion device according to claim 10, wherein the second positioning section is disposed to the end portion of the device on the base side on inner wall surfaces that face each other, of the first and second side wall sections.

12. The continuous passive motion device according to claim 10, wherein the driving means is contained in the first side wall section.

13. The continuous passive motion device according to claim 12, wherein the driving means has: a driving pulley disposed coaxially with the second rotary shaft; a driving wire wound around the driving pulley; a first tube-shaped air actuator connected to an end portion of the driving wire and to an inside of the first side wall section; and a second tube-shaped air actuator connected to the other end portion of the driving wire and to the inside of the first side wall section, the tube-shaped air actuators being reduced and extended in length by supplying and discharging air, to thereby produce a driving force.

14. The continuous passive motion device according to claim 1, wherein the driving means is a tube-shaped air actuator which is contracted and extended in length by supplying and discharging air, to thereby produce a driving force.

15. The continuous passive motion device according to claim 1, wherein rollers are provided at an end portion of the lower-leg-holding section opposite to the link member.

16. The continuous passive motion device according to claim 10, wherein a pair of holders are provided at positions on inner surfaces of the first and second side wall sections which correspond to the second rotary shaft, and a flexible belt is provided between the first and second side wall sections via the holders.
